(19) United States
(12) Patent Application Publication
(10) Pub. No.: US 2015/0204082 A1
(43) Pub. Date: Jul. 23, 2015

(54) CORK TILE AND METHOD OF MAKING THE TILE

(71) Applicant: LACU S.r.l, Luogosanto (Olbia-Tempio) (IT)

(72) Inventor: Michele Lacu, Luogosanto (Olbia-Tempio) (IT)

(21) Appl. No.: 14/424,837

(22) PCT Filed: Sep. 3, 2013
(86) PCT No.: PCT/IB2013/058252

§ 371 Date: Feb. 27, 2015

(30) Foreign Application Priority Data
Sep. 5, 2012 (IT) BO2012A000470

(51) Int. Cl. E04F 15/10; B05D 3/12; B05D 1/38; B44F 1/14; B44C 3/12

(52) U.S. Cl. CPC E04F 15/102; B44F 1/14; B44C 3/123; B05D 1/38; B05D 3/12

(57) ABSTRACT

A cork tile includes a body of agglomerated cork having a first face applicable to a wall to be covered and a second face opposite the first face and a covering material laid over and anchored to the second face of the body. The covering material includes a base layer laid over the second face of the body and having adhesive properties so it can be attached thereto, and a plurality of marble particles of at least one predetermined colour laid over the base layer and distributed thereon with a variable density in order to produce coloured zones in variable shades in such a way that the base layer is visible at the zones with a low density of marble particles.

### TECHNICAL FIELD

This invention relates to a tile made of cork and a method and an installation) for making the tile.

The invention is applicable in particular to the sector of building construction and, more specifically, to the manufacture of tiles.

### BACKGROUND ART

in the current state of the art, cork tiles are made from a mixture of cork granules (process chippings or waste) and adhesive. The mixture is compressed in suitable machines to obtain flat, high-density, high-strength panels.

To increase the wear resistance of these panels, they are coated with transparent varnishes 17 which protect them from external agents, even after being treaded on, without spoiling their appearance.

After the protective varnish has been applied, the panels are cut to obtain tiles of diverse shapes and sizes.

Also, by suitably processing the mixture, it is possible to create also on the cork tiles the designs typical of wooden mosaics and to recreate on the floor the effect of antique decorated parquet flooring.

Disadvantageously, up to now, the cork tile market has been limited by the impossibility of using this technology to recreate the effect of marble or ceramic floors.

More specifically, to date, it is not possible to fuse the technical properties of cork with the aesthetic qualities of other materials, such as, for example, marble.

### DISCLOSURE OF THE INVENTION

The aim of this invention is to provide a cork tile and a method of making the tile which overcome the above mentioned drawbacks of the prior art.

More specifically, the aim of this invention is to provide an extremely economical tile with an innovative appearance.

Another aim of the invention is to implement a cork tile making method which is at once simple and capable of providing a tile with an innovative appearance.

These aims are fully achieved by the cork tile of the invention, comprising a body of agglomerated cork having a first face applicable to a wall to be covered and a second face, opposite the first face, and a covering material laid over and anchored to the second face of the body.

According to the invention, the covering material comprises a base layer laid over the second face of the body and having adhesive properties so it can be attached thereto, and a plurality of marble particles of at least one predetermined colour laid over the base layer and distributed thereon with a variable density in order to produce coloured zones in variable shades in such a way that the base layer is visible at the zones with a low density of marble particles.

Advantageously, it is thus possible to obtain a cork tile having a novel and surprising appearance, capable of reproducing the effect of marble but without the disadvantages of marble (such as, for example, cost, weight, high thermal conductivity and difficulty of working).

According to the invention, the tile is made using a production method according to claims 7 to 15, which comprises a step of preparing a cork panel with a substantially flat shape and having a first face and a second face, opposite the first face, and a step of applying a covering material on the second face of the panel. According to the invention, the step of applying the covering material comprises a step of applying on the second face of the tile body a mixture having adhesive properties in order to define a base layer, and a step of applying a plurality of marble particles of at least one predetermined colour spread non-uniformly on the base layer in order to produce coloured zones in variable shades.

From the foregoing, it is evident that the cork tile, besides having functionally and aesthetically innovative features, is made according to a method which is at once simple, fast and particularly inexpensive.

### BRIEF DESCRIPTION OF DRAWINGS

These and other features of the invention will become more apparent from the following detailed description of a preferred, non-limiting example embodiment of it, with reference to the accompanying drawings, in which:

FIG. 1 shows a perspective view and a cross section of a cork tile according to this invention;

FIG. 2 schematically illustrates an installation which implements the method of making a cork tile according to the invention;

FIG. 3 is a plan view of the tile of FIG. 1.

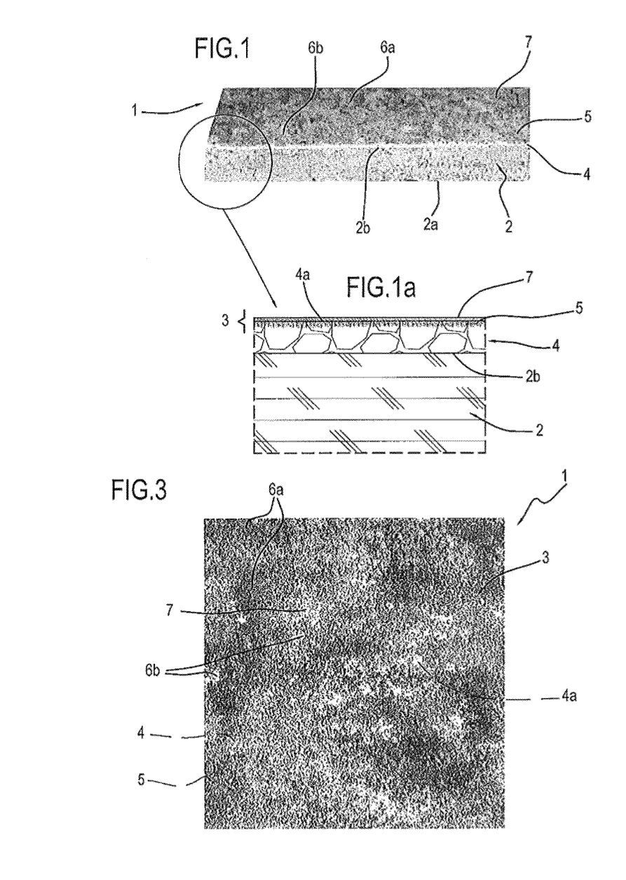

### DETAILED DESCRIPTION OF THE PREFERRED EMBODIMENTS OF THE INVENTION

With reference to the accompanying drawings, the numeral 1 denotes a cork tile according to this invention.

The tile 1 comprises a body 2 of agglomerated cork having a first face 2a applicable to a wall to be covered and a second face 2b opposite the first face 2a.

The body 2 is a plate-like element (that is, substantially flat) having the geometry of a tile and a thickness which is preferably variable in a range between 2 and 10 mm, depending on applications.

The body 2 is made from cork granules of different grain sizes bonded to each other by a glue (preferably polyurethane based). Preferably, the grain size used is between 0.5 mm and 15 mm (more preferably, between 1 and 12 mm).

The second face 2b of the body is coated with a composite covering material 3, described in more detail below.

Preferably, the total thickness of the layer of covering material is between 0.2 and 0.5 mm. and more preferably, approximately 0.3 mm.

The material 3 comprises a base layer 4 laid over the second face 2b of the body 2 and having adhesive properties so it can be attached thereto.

Preferably, the layer 4 has an outside face 4a (that is, directed away from the body 2) having a smooth, regular surface, that is to say, a flat surface, obtained by smoothing operations (described below).

Thus, the base layer 4 has a thickness of between 0.2 and 0.4 mm, preferably approximately 0.3 mm.

Preferably, the base layer 4 is substantially white in colour (that is, with RGB coordinates greater than 220 in all three fields).

To obtain this colour, the base layer 4 is made from a mixture comprising at least a percentage of resin (preferably a polyurethane resin). The percentage is preferably greater than 50%.

More precisely, the base layer 4 is defined by a mixture comprising a percentage of resin and a plurality of mineral charges.

The expression “mineral charges” is used to mean microparticles (that is, very fine, impalpable powders) of natural, inorganic substances, such as silicon and quartz.

Preferably, these microparticles are obtained by micronizing the minerals.

Thus, the base layer 4 defines a white film distributed uniformly on the second face 2b of the body 2.

It should be noted that the use of a polyurethane resin and a plurality of mineral charges also gives the base layer 4 the function of stiffening the body 2, increasing the structural strength of the tile 1.

According to the invention, the tile 1 (more specifically, the covering material 3) also comprises a plurality of marble particles 5, of at least one predetermined colour, laid over the second face 2b of the body 2, and, in particular, over the base layer 4 The particles 5 are preferably distributed over the base layer 4 in non-uniform manner.

In other words, the base layer 4 is interposed between the body 2 (in particular, the second face 2b thereof) and the marble particles 5 and holds them together. Thus, the base layer defines connecting means between the marble particles 5 and the body 2.

It should be noted that the marble particles 5 protrude at least partly “visibly” from the outside face 4a of the base layer 4 and are thus visible to a user. Preferably, the marble particles 5 have a grain size of between 0 and 2 millimetres (more preferably, between 0 and 1 mm).

As mentioned above, the marble particles 5 are distributed over the connecting layer 4 in non-uniform manner, that is, with variable density, in such a way as to define coloured zones in variable shades.

In other words. the marble particles 5 are distributed non-uniformly over the surface of the body 2, defining high-density zones 6a which are intensely coloured, and low-density zones 6b where the base layer 4 is visible, thus creating lightly-coloured striations typical of marble tiles.

Thus, it is evident that the base layer 4, being substantially white in colou constitutes an ideal base for applying the marble powder.

Advantageously, this provides a tile 1 which is identical in appearance to a marble tile but whose functional and economic features are totally different.

In order to prevent excessive wear of the surface layer of the tile 1, the covering material 3 comprises a transparent protective layer 7 laid over the marble particles 5 and over the base layer 4.

The protective layer 7 is preferably made of a two-component polyurethane varnish.

Alternatively, an acrylic varnish (of UV type) or the like might be used.

Another object of this invention is a method for making a cork tile, in particular for making the cork tile 1 described up to now.

The first step is to prepare a panel 12 of agglomerated cork having a first face 12a applicable to a wall to be covered and a second face 12b opposite the first face 12a.

After being cut and machined, the panel 12 will define the body 2 of the tile 1, just described.

Operatively, the panel 12 is made from granules and adhesive mixed together in suitable mixers (not illustrated).

The mixture (of granules and adhesive) is then compressed in suitable moulds to obtain a high-density material.

Once the cork granules and the adhesive have been bonded together, the panels 12 are extracted from the moulds and cut, based on the required thickness.

In a preferred embodiment, the cut panels 12, before proceeding to the next step, are gauged and sanded so as to obtain a uniform thickness and a smooth surface.

According to the method, the panel 12 is then covered with a covering material 3 in a sequence of operating steps.

More specifically, once the panels 12 have been prepared, the method of the invention comprises a step of applying on the second face 12b of the panel 12a mixture 14 which has adhesive properties in order to define the base layer 4 of the tile 2.

It should be noted that from this moment, the mixture 14 and the base layer 4 will be referred to in the same way since they define the same material before and after a drying step, described later.

As described above, the mixture 14 preferably contains at least a percentage (greater than 50%) of resin (polyurethane). The mixture 14 also contains microparticles of minerals, such as quartz and/or silicon embedded in it.

The mixture 14 thus has a relatively high density (coefficient of viscosity greater than Y) and is substantially white in colour (with RGB coordinates greater than 220 in all three fields).

In the preferred embodiment, the step of applying the mixture 14 is divided into at least two substeps: a first substep of laying the mixture 14 on the second face 12b of the panel 12 so as to cover it with a layer of predetermined thickness, and a second substep of smoothing out the layer of material in such a way as to uniformly cover the second face 12b of the panel 12.

Preferably, the mixture 14 is stored in suitable tanks (or baths) 21 and laid over the second face 12b of the panel 12 by suitable transfer means 22

In a first embodiment, the step of laying the mixture comprises the following substeps:
preparing a bath 21 comprising the mixture 14;
dipping at least part of a transfer means 22 into the bath 21 to collect a defined portion of mixture 14;
transporting a layer of mixture 14 through the agency of the transfer means 22;
applying that layer of mixture 14 to the second face 12b of the panel 12 of agglomerated cork by causing the transfer means 22 to come into contact with the panel 12.

In other words, applying the mixture 14 is performed by rotogravure or offset (transfer) printing.

After this substep, the thickness of the layer of mixture 14 is greater than 0.30 mm (usually around 0.50 mm).

In order to spread the mixture 14 evenly, the smoothing substep is preferably accomplished by calendering (or similar processes), where the panels 12 covered by the layer of mixture 14 are made to pass between suitable rollers or cylinders 23 (of steel).

According to the method of the invention, the step of applying the mixture 14 is followed by a step of applying a plurality of marble particles 5 on the “smoothed out” layer of mixture 14 (similar to the base layer 4).

Preferably, the particles 5 are of at least one predetermined colour, depending on the type of marble from which the particles 5 have been obtained.

In effect, the marble particles 5 are grains of marble of fine grain size obtained or recycled from marble process waste or chippings.

Preferably, these grains vary in size from 0 to 1 mm, and more preferably are less than 0.5 mm in size.

in the preferred embodiments, the marble particles 15 have the following colours:
Botticino (white);
Aipi (green);
Assoluto (black);
Oro (yellow);
Verona (red);
CoraIlo (salmon).

Preferably, during the step of applying them, the marble particles 15 are distributed unevenly (that is, non-uniformly) over the surface of the base layer 4 in order to produce coloured zones in variable shades.

Thus, the density of marble particles 5 is variable (in a totally random manner) on the outside face 4a of the base layer 4 so as to define high-density zones 6a which are intensely coloured, and low-density zones 6b where the base layer 4, that is, the mixture 14, is visible (thus creating lightly-coloured striations typical of marble tiles).

Preferably, the step of applying the plurality of marble particles 5 is followed by sieving, that is distributing the particles of a predetermined size through the agency of a vibratory sieve 24 (or vibroscreen).

Advantageously, it is thus quick and easy to unevenly distribute the marble particles 5 of the correct grain size.

That way, the particles 5 are deposited on the mixture 14, in which they are at least partly embedded, in order to bond them to the panel 12.

In order to strengthen the bond, the method comprises, after the step of applying the plurality of particles 5, a step of compacting them with the mixture 14 (that is, with the base layer 4).

The marble powder is thus totally fixed onto the mixture 14 of mineral and resin charges.

Preferably, the compacting step comprises a first and a second substep of compressing the marble particles 5 on the mixture 14 (that is on the base layer 4) performed one after the other with increasing compressive force,

In the same way as the smoothing step described above, the compacting step is accomplished by calendering.

In the embodiment illustrated, the powder compacting step is performed by a set of calenders differing in hardness,

More specifically, the first compressing substep is performed by first calenders 25 equipped with at least one operating (peripheral) portion made of a spongy material configured to compliantly compress the particles 5.

The second compressing substep is performed by second calenders 26 made of hard rubber and configured to apply a more intense compressive force on the panel 12.

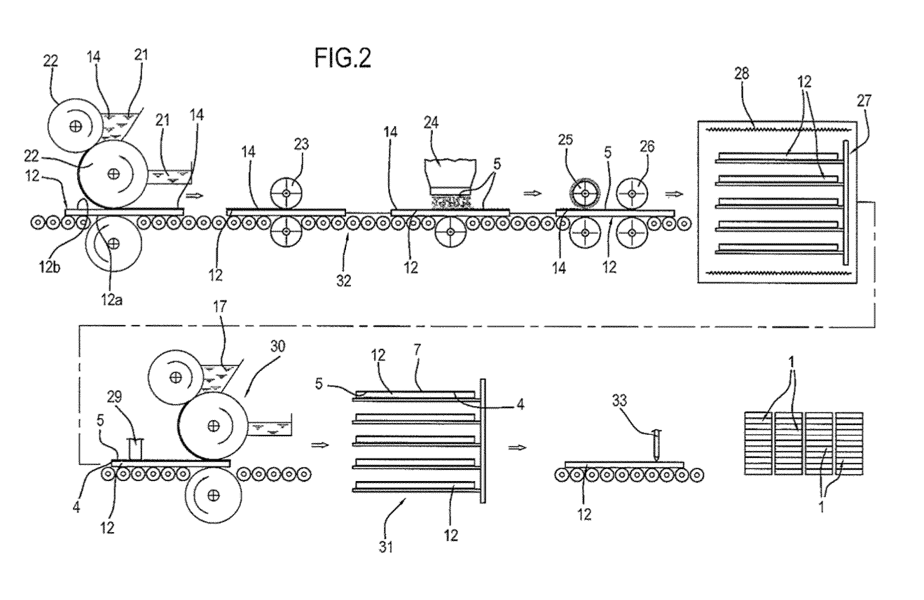

It should be noted that all the steps described up to now are preferably performed in succession in a dedicated installation equipped with movement means 32 (defined by roller conveyors in FIG. 2) for transporting the panel 12 from one station to the next.

Preferably, after this compacting step, the method comprises a step of drying the panel 12 (covered with the mixture 14 and the particles 5).

This drying step is performed preferably by placing the panel 2 on suitable racks 27 for a predetermined length of time.

In the embodiment illustrated, the drying step is speeded up by using suitable ovens 28.

More specifically, the ovens 28 are set at a temperature of between 25 and 40° C., preferably between 30 and 35° C., so as to allow the mixture 14 and the panel 12 to dry completely.

In the optimum embodiment, the panels 12 are left in the ovens 28 for a length of time of between 6 and 12 hours, preferably approximately 8 hours.

Once dry, the mixture 14 defines, to all intents and purposes, the base layer 4 of the tile 1.

After the drying step, the method comprises a step of removing the excess marble particles 5 from the base layer 4.

Preferably, this step comprises a substep of brushing carried out with a hard brush 29 configured to remove the excess particles 5, leaving the surface smooth and clean.

Next, in order to increase the strength and robustness of the tile 1, the particles 5 and the base layer 4 are covered with a protective layer 7.

Covering is accomplished by applying a transparent protective material 17, preferably polyurethane varnish (or, alternatively, UV acrylic varnish).

In the embodiment illustrated, the step of applying the transparent protective material 17 is performed by spreading and coating machines 30.

To allow the transparent varnish to dry completely, the panels 12 are subjected to a further drying step, preferably on further racks 31.

For this drying step, ovens are not required because it is sufficient to let the varnish dry in air.

In order to make the tiles 1, each panel 12 is then cut (by suitable cutting means 33) according to specific customers' specifications, thus defining the geometry of the bodies 2 of the tiles 1.

The invention achieves the preset aims ad brings important advantages.

Indeed, the combination of the connecting layer and the marble particles makes it possible to make a tile which looks just like marble but is light, inexpensive ad thermally insulating like cork.

Advantageously, the use of a polyurethane resin combined with microparticles of minerals (such as silicon and quartz) makes it possible to obtain a connecting layer which is white in colour, perfect as a base for the application of the marble particles.

It should be noted that the use of a vibroscreen (and, hence, of sieving) for applying these particles makes the marble effect realistic and of very high quality.

Moreover, the particles used to make the tiles are obtained by “recycling” chippings and waste from the production of marble worktops, thus making the tiles as economical as they are functional.

1. A cork tile, comprising:
a body of agglomerated cork having a first face applicable to a wall o be covered and a second face opposite the first face;
a covering material laid over and anchored to the second face of the body; wherein the covering material comprises a base layer laid over the second face of the body and having adhesive properties so that it can be attached thereto, and a plurality of marble particles of at least one predetermined colour laid over the base layer and distributed thereon with a variable density in order to produce coloured zones in variable, shades in such a way that the base layer is visible at the zones with a low density of marble particles.

2. The cork tile according to claim 1, wherein the base layer comprises at least one percentage of resin.

3. The cork the according to claim 1, wherein the base layer is defined by a mixture comprising a percentage of resin and a plurality of mineral microparticles.

4. The cork tile according to claim 1 wherein the base layer is substantially white in colour so that the zones with low density of marble particles reproduce corresponding light-coloured striations typical of marble.

5. The cork tile according to claim 1, wherein the marble particles have a grain size of less than 1 millimetre.

6. The cork tile according to claim 1, wherein the covering material comprises a transparent wear layer laid over the marble particles and over the base layer.

7. A method for making a cork tile, comprising the following steps:
preparing a cork panel with a substantially flat shape and having a first face and a second face, opposite the first face;
applying a covering material on the second face of the panel; wherein the step of applying the covering material comprises the following steps:
applying a mixture having adhesive properties on the second face of the panel;
applying a plurality of marble particles of at least one predetermined colour laid on the mixture, distributing them thereon in a non-uniform manner in order to produce coloured zones in variable shades.

8. The method according to claim 7, wherein the step of applying the mixture is divided at least into:
a substep of laying the mixture on the second face of the panel;
a substep of smoothing the mixture in such a way as to uniformly cover the second face of the panel with a layer of mixture of constant thickness.

9. The method according to claim 7, wherein the step of applying the plurality of marble particles is followed by sieving of the particles.

10. The method according to claim 7, wherein it comprises a compacting step after the step of applying the plurality of marble particles in order to strengthen particle attachment to the mixture.

11. The method according to claim 10, wherein the compacting step comprises a first and a second sub-step of compressing the marble particles on the mixture performed one after the other with increasing compressive force.

12. The method according to claim 10, wherein the compacting step is performed by calendering.

13. The method according to claim 7, wherein it comprises a step of drying the panel after the step of applying the marble particles; the mixture, after drying, defining a base layer of the covering material.

14. The method according to claim 7, wherein it comprises a step of removing the excess marble particles from the base layer after the drying step.

15. The method according to claim 7, wherein it comprises a step of applying a transparent protective material after the step of applying the marble particles in order to make a wear layer of a treadable surface of the tile,
